(19) United States
(12) Patent Application Publication
(10) Pub. No.: US 2022/0275234 A1
(43) Pub. Date: Sep. 1, 2022

(54) Aqueous Ink-Jet Ink Composition

(71) Applicant: Seiko Epson Corporation, Tokyo (JP)

(72) Inventors: Manabu TANIGUCHI, Shiojiri (JP); Tomohito NAKANO, Shiojiri (JP); Tomoki MARUYAMA, Matsumoto (JP); Kiyomi KUMAMOTO, Kitakyushu (JP); Jun ITO, Shimosuwa (JP); Tetsuya AOYAMA, Shiojiri (JP); Satoshi TSUBAMOTO, Shiojiri (JP); Masahiro YATAKE, Shiojiri (JP); Yukiko Il, Suwa (JP)

(21) Appl. No.: 17/680,532

(22) Filed: Feb. 25, 2022

(30) Foreign Application Priority Data
Feb. 26, 2021 (JP) 2021-029957

(51) Int. Cl. C09D 11/38; C09D 11/322; C09D 11/033; C09D 11/037; C09D 11/102; C09D 11/107; C09D 11/023

(52) U.S. Cl. CPC C09D 11/38; C09D 11/322; C09D 11/033; C09D 11/037; C09D 11/102; C09D 11/107; C09D 11/023

(57) ABSTRACT

An aqueous ink-jet ink composition according to the present disclosure contains pigment, water, resin particles, 1-(2-hydroxyethyl)-2-pyrrolidone, and trimethylglycine. The mass-based content of the resin particles is lower than the mass-based content of the pigment.

The present application is based on, and claims priority from JP Application Serial Number 2021-029957, filed Feb. 26, 2021, the disclosure of which is hereby incorporated by reference herein in its entirety.

### BACKGROUND

### 1. Technical Field

The present disclosure relates to an aqueous ink-jet ink composition.

### 2. Related Art

An ink jet recording method is a method in which recording is performed in such a manner that ink droplets are discharged from a fine nozzle and are applied to a recording medium. This method has a feature that a high-resolution, high-quality image can be rapidly recorded with a relatively inexpensive device. Various investigations have been made on an aqueous ink-jet ink composition for use therein.

Hitherto, in order to improve the fixability of pigment serving as a coloring agent of ink to a recording medium, it has been proposed that resin particles are added to an aqueous ink-jet ink composition. For example, JP-A-2008-156653 describes an aqueous ink-jet ink composition containing pigment and resin particles.

However, in order to obtain good fixability, the content of resin particles generally needs to be increased. On the other hand, increasing the content of the resin particles is likely to dry the resin particles in a nozzle, for example, leading to a problem that the nozzle is unlikely to be unclogged even if cleaning is performed, that is, a problem that unclogging properties are poor. Therefore, it is required that both good fixability and good unclogging properties can be ensured.

### SUMMARY

According to an aspect of the present disclosure, an aqueous ink-jet ink composition contains pigment, water, resin particles, 1-(2-hydroxyethyl)-2-pyrrolidone, and trimethylglycine. The mass-based content of the resin particles is lower than the mass-based content of the pigment.

### BRIEF DESCRIPTION OF THE DRAWINGS

FIG. 1 is a schematic view of an ink jet recording apparatus equipped with a line head.

FIG. 2 is a schematic plan view of a line head.

### DESCRIPTION OF EXEMPLARY EMBODIMENTS

Some embodiments of the present disclosure are described below. The embodiments below illustrate examples of the present disclosure. The present disclosure is not in any way limited to the embodiments below and includes various modifications made without departing from the gist of the present disclosure. All of components described below are not necessarily components essential for the present disclosure.

### 1. Aqueous Ink-Jet Ink Composition

An aqueous ink-jet ink composition according to an embodiment of the present disclosure contains pigment, water, resin particles, 1-(2-hydroxyethyl)-2-pyrrolidone, and trimethylglycine. The mass-based content of the resin particles is lower than the mass-based content of the pigment.

In accordance with the aqueous ink-jet ink composition according to this embodiment, since 1-(2-hydroxyethyl)-2-pyrrolidone (herein simply referred to as “HEP” in some cases) is contained, good fixability can be obtained even if the content of the resin particles is low relative to the pigment. In other words, since HEP is contained, good fixability can be ensured and the content of the resin particles, which cause the clogging of a nozzle, can be reduced. HEP is presumed to have an effect of redistributing a dried ink composition to readily perform cleaning. Furthermore, trimethylglycine, which is excellent in moisture retention, is contained and is therefore presumed to reduce the drying of the ink composition. These interactions enable both good unclogging properties and good fixability to be ensured.

Components contained in the aqueous ink-jet ink composition (hereinafter also referred to as the “ink composition”) according to this embodiment are described below.

### 1.1. Pigment

The aqueous ink-jet ink composition according to this embodiment contains the pigment. Examples of the pigment include inorganic pigments and organic pigments. The hue of the pigment is not particularly limited and may be a so-called process color such as cyan, magenta, yellow, or black or a so-called spot color such as white, a fluorescent color, or a glitter color.

The inorganic pigments used may be carbon blacks (C. I. Pigment Black 7) such as furnace black, lamp black, acetylene black, and channel black; iron oxide; titanium oxide; zinc oxide; silica; and the like.

Examples of carbon black include No. 2300, 900, MCF 88, No. 20B, No. 33, No. 40, No. 45, No. 52, MA 7, MA 8, MA 100, and No. 2200B produced by Mitsubishi Chemical Corporation. For example, Color Black FW1, FW2, FW2V, FW18, FW200, S150, S160, S170, Printex 35, U, V, 140U, Special Black 6, 5, 4A, 4, and 250 produced by Degussa AG can be exemplified as carbon black. For example, Conductex SC, Raven 1255, 5750, 5250, 5000, 3500, 1255, and 700 produced by Columbian Carbon Company can be exemplified as carbon black. For example, Regal 400R, 330R, 660R, Mogul L, Monarch 700, 800, 880, 900, 1000, 1100, 1300, 1400, and Elftex 12 produced by Cabot Corporation can be exemplified as carbon black. Furthermore, for example, Bonjet Black CW-1, CW-1S, CW-2, CW-3, and M-800 produced by Orient Chemical Industries, Ltd. can be exemplified as carbon black.

For example, a quinacridone pigment, a quinacridonequinone pigment, a dioxazine pigment, a phthalocyanine pigment, an anthrapyrimidine pigment, an anthanthrone pigment, an indanthrone pigment, a flavanthrone pigment, a perylene pigment, a diketopyrrolopyrrole pigment, a perinone pigment, a quinophthalone pigment, an anthraquinone pigment, a thioindigo pigment, a benzimidazolone pigment, an isoindolinone pigment, an azomethine pigment, or an azo pigment can be exemplified as an organic pigment.

Examples of a cyan pigment include C. I. Pigment Blues 1, 2, 3, 15:3, 15:4, 15:34, 16, 22, and 60 and C. I. Vat Blues 4 and 60. Preferably, one selected from the group consisting of C. I. Pigment Blues 15:3, 15:4, 15:34, and 60 or a mixture of two or more selected from this group can be exemplified.

Examples of a magenta pigment include C. I. Pigment Reds 5, 7, 12, 48 (Ca), 48 (Mn), 57(Ca), 57:1, 112, 122, 123, 168, 184, and 202 and C. I. Pigment Violet 19. Preferably, one selected from the group consisting of C. I. Pigment Reds 122, 202, and 209 and C. I. Pigment Violet 19 or a mixture of two or more selected from this group can be exemplified.

Examples of a yellow pigment include C. I. Pigment Yellows 1, 2, 3, 12, 13, 14C, 16, 17, 73, 74, 75, 83, 93, 95, 97, 98, 119, 110, 114, 128, 129, 138, 150, 151, 154, 155, 180, and 185. Preferably, one selected from the group consisting of C. I. Pigment Yellows 74, 109, 110, 128, and 138 or a mixture of two or more selected from this group can be exemplified.

C. I. Pigment Orange 36 or 43 or a mixture of C. I. Pigment Oranges 36 and 43 can be exemplified as an orange pigment. C. I. Pigment Green 7 or 36 or a mixture of C. I. Pigment Greens 7 and 36 can be exemplified as a green pigment.

A glitter pigment is not particularly limited and may be one capable of exhibiting glitter when being applied to a medium. For example, particles of one selected from the group consisting of aluminium, silver, gold, platinum, nickel, chromium, tin, zinc, indium, titanium, and copper or an alloy (also referred to as a metal pigment) of two or more selected from this group or a pearl pigment with a pearly luster can be cited. Representative examples of the pearl pigment include pigments, such as titanium dioxide-coated mica, fish scale flake, and bismuth oxychloride, having a pearly luster or an interference luster. The glitter pigment may be surface-treated for the purpose of suppressing a reaction with water.

Examples of a white pigment include metal compounds such as metal oxides, barium sulfate, and calcium carbonate. Examples of the metal oxides include titanium dioxide, zinc oxide, silica, alumina, and magnesium oxide. The white pigment used may be particles with a hollow structure.

The pigment is preferably added to the ink composition in the form of a pigment dispersion obtained by dispersing the pigment in water with a dispersant such as resin or a surfactant or in the form of a self-dispersing pigment.

### Self-Dispersing Pigment

The self-dispersing pigment is pigment that can be dispersed and/or dissolved in an aqueous medium without resin or a dispersant such as a surfactant. As used herein, the phrase “dispersed and/or dissolved in an aqueous medium without a dispersant” refers to a state that pigment is stably present in an aqueous medium because of a surface hydrophilic group thereof even if a dispersant for dispersing the pigment is not used.

When the ink composition contains the self-dispersing pigment, the ink composition need not contain a dispersant for dispersing pigment, causes little foaming because of a reduction in defoaming capacity due to the dispersant, and is readily prepared so as to have excellent discharge stability. The ink composition is excellent in discharge reliability because the occurrence of foreign substances due to drying caused by the dispersant at an air-liquid interface is suppressed. Furthermore, since a significant increase in viscosity due to the dispersant is suppressed, a larger amount of pigment can be contained and print density can be sufficiently increased.

Examples of a surface hydrophilic group of the self-dispersing pigment include -OM, —COOM, —CO—, —SO₃M, —SO₂M, —SO₂NH₂, —RSO₂M, —PO₃HM, —PO₃M₂, —SO₂NHCOR, —NH₂, and —NR₂, where M represents a hydrogen atom, an alkali metal, ammonium, or organic ammonium and R represents a naphthyl group that may have an alkyl group containing one to 12 carbon atoms or a substituent.

When carbon black is converted into the self-dispersing pigment, the self-dispersing pigment is produced in such a manner that the carbon black is subjected to, for example, a physical or chemical treatment such that a hydrophilic group is bonded (grafted) to the surface of the carbon black. The physical treatment is, for example, a vacuum plasma treatment or the like. The chemical treatment is, for example, an oxidation treatment with a hypohalous acid and/or a hypohalite, an oxidation treatment with ozone, an oxidation treatment with persulfuric acid and/or a persulfurate, or the like.

A commercially available product can be used as carbon black converted into the self-dispersing pigment and, for example, CAB-O-JET® 300 (produced by Cabot Specialty Chemicals Inc.) or the like is cited.

On the other hand, a self-dispersing pigment of a color pigment other than carbon black is produced by bonding a hydrophilic group to the surface of pigment with a phenyl group therebetween. Various known surface treatment means can be used as a surface treatment means to bond a functional group which is the hydrophilic group or a salt thereof to the pigment surface with the phenyl group therebetween. For example, a method in which the hydrophilic group is bonded to the pigment surface with the phenyl group therebetween by bonding sulfanilic acid, p-aminobenzoic acid, 4-aminosalicylic acid, or the like to the pigment surface is cited. Examples of the color pigment other than carbon black include pigments such as pigment yellows, pigment reds, pigment violets, and pigment blues listed in a color index; pigments such as phthalocyanine pigments, azo pigments, anthraquinone pigments, azomethine pigments, and condensed ring pigments; organic pigments such as Yellow No. 4, Yellow No. 5, Yellow No. 205, Yellow No. 401, Orange No. 228, Orange No. 405, Blue No. 1, and Blue No. 404; and inorganic pigments such as titanium oxide, zinc oxide, zirconium oxide, iron oxide, ultramarine blue, iron blue, and chromium oxide.

A commercially available product can be used as such a self-dispersing pigment of a color pigment and, for example, CAB-O-JET® 250C, CAB-O-JET® 260M, and CAB-O-JET® 470Y (the above being produced by Cabot Specialty Chemicals Inc.) are cited.

The content of the pigment (solid matter) is preferably 3% by mass or more and more preferably 4% by mass or more with respect to the amount (100% by mass) of the ink composition. The content of the pigment (solid matter) is preferably 8% by mass or less, more preferably 7% by mass or less, and particularly preferably 6% by mass or less with respect to the amount (100% by mass) of the ink composition. When the content of the pigment (solid matter) is in the above range, unclogging properties are more excellent in some cases.

The aqueous ink-jet ink composition according to this embodiment is such that the mass-based content of the resin particles below is lower than the mass-based content of the pigment. The aqueous ink-jet ink composition according to this embodiment satisfies the quantitative ratio relationship between the resin particles and the pigment and therefore can ensure both good fixability and good unclogging properties.

### 1.2. Water

The aqueous ink-jet ink composition according to this embodiment contains water. An “aqueous” composition is a composition in which water is one of major solvents. Examples of water include pure water products such as ion-exchanged water, ultrafiltered water, reverse osmosis-purified water, and distilled water and those, such as, ultrapure water, containing reduced amounts of ionic impurities. Using water sterilized by, for example, ultraviolet irradiation or the addition of hydrogen peroxide enables the development of bacteria or fungi to be suppressed when the aqueous ink-jet ink composition is stored for a long period of time.

The content of water is preferably 30% by mass or more, more preferably 40% by mass or more, further more preferably 45% by mass or more, and still further more preferably 50% by mass or more with respect to the amount (100% by mass) of the ink composition. The content of water is preferably 90% by mass or less, more preferably 85% by mass or less, and further more preferably 80% by mass or less with respect to the amount (100% by mass) of the ink composition.

### 1.3. Resin Particles

The aqueous ink-jet ink composition according to this embodiment contains the resin particles.

The resin particles are those made of, for example, a urethanic resin, an acrylic resin (including a styrene-acrylic resin), a fluorene resin, a polyolefinic resin, a rosin-modified resin, a terpene resin, a polyester resin, a polyamide resin, an epoxy resin, a vinyl chloride resin, a vinyl chloride-vinyl acetate resin, or an ethylene-vinyl acetate resin. In particular, the urethanic resin, the acrylic resin, the polyolefinic resin, or the polyester resin is preferable. The resin particles are often handled in the form of emulsion and may be in the form of powder. The resin particles may be used alone or in combination with other resin particles.

The urethanic resin is a generic term for resins containing a urethane bond. The urethanic resin used may be, for example, a polyether urethane resin containing an ether bond in a main chain, a polyester urethane resin containing an ester bond in a main chain, or a polycarbonate urethane resin containing a carbonate bond in a main chain in addition to a urethane bond. The urethanic resin used may be a commercially available product and may be, for example, Superflex 420, 460, 460s, 840, or E-4000 (trade name, produced by Dai-ichi Kogyo Seiyaku Co., Ltd.); Resamine D-1060, D-2020, D-4080, D-4200, D-6300, or D-6455 (trade name, produced by Dainichiseika Color & Chemicals Mfg. Co., Ltd.); Takelac WS-5100, WS-6021, or W-512-A-6 (trade name, produced by Mitsui Chemical Polyurethane Inc.); Sancure 2710 (trade name, produced by Lubrizol Corporation); or Permarin UA-150 (trade name, produced by Sanyo Chemical Industries, Ltd.).

The acrylic resin is a generic term for polymers obtained by polymerizing at least an acrylic monomer such as (meth)acrylic acid or a (meth)acrylic ester as one component. Examples of the acrylic resin include resins obtained from an acrylic monomer and copolymers of an acrylic monomer and monomers other than the acrylic monomer. For example, an acrylic vinyl resin that is a copolymer of an acrylic monomer and a vinylic monomer and the like are cited. For example, styrene or the like is cited as a vinylic monomer.

Herein, the acrylic resin may be a styrene-acrylic resin below. Herein, the expression “(meth)acrylic” means at least one of “acrylic” and “methacrylic”.

The styrene-acrylic resin is a copolymer obtained from a styrene monomer and a (meth)acrylic monomer. Examples of the styrene-acrylic resin include styrene-acrylic acid copolymers, styrene-methacrylic acid copolymers, styrene-methacrylic acid-acrylic ester copolymers, styrene-α-methylstyrene-acrylic acid copolymers, and styrene-α-methylstyrene-acrylic acid-acrylic ester copolymers. The styrene-acrylic resin used may be a commercially available product and may be, for example, Joncryl 62J, 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, or 7610 (trade name, produced by BASF); Mowinyl 966A or 975N (trade name, produced by The Nippon Synthetic Chemical Industry Co., Ltd.); or Vinyblan 2586 (trade name, produced by Nissin Chemical Industry Co., Ltd.).

The polyolefinic resin is one having a structural skeleton derived from an olefin such as ethylene, propylene, or butylene and may be a known one appropriately selected. The polyolefinic resin used may be a commercially available product and may be, for example, ARROWBASE CB-1200 or CD-1200 (trade name, produced by Unitika Ltd.).

The resin particles may be supplied in the form of emulsion. Examples of a commercially available product of such a resin emulsion include Microgels E-1002 and E-5002 (produced by Nippon Paint Co., Ltd., trade names, styrene-acrylic resin emulsions); Voncoat 4001 (produced by DIC Corporation, trade name, acrylic resin emulsion); Voncoat 5454 (produced by DIC Corporation, trade name, styrene-acrylic resin emulsion); Polysols AM-710, AM-920, AM-2300, AP-4735, AT-860, and PSASE-4210E (acrylic resin emulsions); Polysol AP-7020 (styrene-acrylic resin emulsion); Polysol SH-502 (vinyl acetate resin emulsion); Polysols AD-13, AD-2, AD-10, AD-96, AD-17, and AD-70 (ethylene-vinyl acetate resin emulsions); Polysol PSASE-6010 (ethylene-vinyl acetate resin emulsion) (produced by Showa Denko K.K., trade name); Polysol SAE 1014 (trade name, styrene-acrylic resin emulsion, produced by ZEON Corporation); Saibinol SK-200 (trade name, acrylic resin emulsion, produced by Saiden Chemical Industry Co., Ltd.); AE-120A (produced by JSR Corporation, trade name, acrylic resin emulsion); AE373D (produced by Emulsion Technology Co., Ltd., trade name, carboxy-modified styrene-acrylic resin emulsion); Seikadain 1900W (produced by Dainichiseika Color & Chemicals Mfg. Co., Ltd., trade name, ethylene-vinyl acetate resin emulsion); Vinyblan 2682 (acrylic resin emulsion); Vinyblan 2886 (vinyl acetate-acrylic resin emulsion); Vinyblan 5202 (acrylic acetate resin emulsion) (produced by Nissin Chemical Industry Co., Ltd, trade name); Elitels KA-5071S, KT-8803, KT-9204, KT-8701, KT-8904, and KT-0507 (produced by Unitika Ltd., trade names, polyester resin emulsions); Hytec SN-2002 (produced by Toho chemical Industry Co., Ltd., trade name, polyester resin emulsion); Takelacs W-6020, W-635, W-6061, W-605, W-635, and W-6021 (produced by Mitsui Chemical Polyurethane Inc., trade names, urethanic resin emulsions); Superflexes 870, 800, 150, 420, 460, 470, 610, and 700 (produced by Dai-ichi Kogyo Seiyaku Co., Ltd., trade names, urethanic resin emulsions); Permarin UA-150 (produced by Sanyo Chemical Industries, Ltd., urethanic resin emulsion); Sancure 2710 (produced by Japan Lubrizol Corporation, urethanic resin emulsion); NeoRezes R-9660, R-9637, and R-940 (produced by Kusumoto Chemicals, Ltd., urethanic resin emulsions); ADEKA BONTIGHTERs HUX-380 and 290K (produced by Adeka Corporation, urethanic resin emulsions); Mowinyls 966A and 7320 (produced by The Nippon Synthetic Chemical Industry Co., Ltd.); Joncryls 7100, 390, 711, 511, 7001, 632, 741, 450, 840, 74J, HRC-1645J, 734, 852, 7600, 775, 537J, 1535, PDX-7630A, 352J, 352D, PDX-7145, 538J, 7640, 7641, 631, 790, 780, and 7610 (the above being produced by BASF); NK Binder R-5HN (produced by Shin-Nakamura Chemical Co., Ltd.); Hydran WLS-210 (non-crosslinked polyurethane: produced by DIC Corporation); Joncryl 7610 (produced by BASF); and X-436 (produced by Seiko Polymer Corporation, styrene-acrylic emulsion).

The content of the resin particles is preferably 0.5% by mass to 5.0% by mass, more preferably 0.5% by mass to 4.7% by mass, further more preferably 0.5% by mass to 4.5% by mass, and particularly preferably 0.5% by mass to 4.2% by mass with respect to the amount (100% by mass) of the ink composition. When the content of the resin particles is in the above range, fixability is excellent and unclogging properties tends to be more excellent.

As described above, the aqueous ink-jet ink composition according to this embodiment is such that the mass-based content of the resin particles is lower than the mass-based content of the pigment. The aqueous ink-jet ink composition according to this embodiment satisfies the quantitative ratio relationship between the resin particles and the pigment and therefore can ensure both good fixability and good unclogging properties.

### 1.4. HEP

The aqueous ink-jet ink composition according to this embodiment contains 1-(2-hydroxyethyl)-2-pyrrolidone (HEP). Hitherto, 2-pyrrolidone has often been used as a solvent for use in ink compositions instead of 1-(2-hydroxyethyl)-2-pyrrolidone. However, it has become clear that containing 1-(2-hydroxyethyl)-2-pyrrolidone allows excellent fixability to be obtained even if the amount of the resin particles is small.

The content of 1-(2-hydroxyethyl)-2-pyrrolidone is preferably 0.1% by mass to 5.0% by mass, more preferably 0.3% by mass to 4.0% by mass, further more preferably 0.5% by mass to 3.0% by mass, and particularly preferably 1.0% by mass to 2.0% by mass with respect to the amount (100% by mass) of the ink composition. When the content of 1-(2-hydroxyethyl)-2-pyrrolidone is in the above range, fixability and unclogging properties are more excellent in some cases.

### 1.5. Trimethylglycine

The aqueous ink-jet ink composition according to this embodiment contains trimethylglycine. Trimethylglycine has a positive charge and negative charge in the same molecule, is a compound of which a molecule has no charge as a whole, and has a structure in which a quaternary ammonium group and a carboxy group are combined with a methylene group therebetween.

Trimethylglycine is solid at room temperature, has low volatility, and therefore has high moisture retention properties. Therefore, trimethylglycine is highly effective as a humectant and can be expected to exhibit an effect of reducing the evaporation of water from the ink composition when trimethylglycine is contained in the ink composition. This probably contributes to an effect of good unclogging properties provided by the aqueous ink-jet ink composition according to this embodiment.

The content of trimethylglycine is preferably 0.1% by mass to 5.0% by mass, more preferably 0.3% by mass to 4.0% by mass, further more preferably 0.5% by mass to 3.0% by mass, and particularly preferably 1.0% by mass to 2.0% by mass with respect to the amount (100% by mass) of the ink composition. When the content of trimethylglycine is in the above range, unclogging properties are more excellent in some cases.

### 1.6. Solvent

The aqueous ink-jet ink composition according to this embodiment preferably contains a glycol ether that is a penetrant as a solvent from a viewpoint that fixability is further enhanced and an effect provided by the present disclosure can be enjoyed. That is, when the penetrant is contained, the dispersibility of an ink component is destabilized and unclogging properties are poor in some cases, though fixability is excellent because of the increase in drying properties of ink. However, in accordance with the aqueous ink-jet ink composition according to this embodiment, even when the penetrant is contained, good unclogging properties can be maintained and, in addition, more excellent fixability can be obtained.

### 1.6.1. Glycol Ether

The aqueous ink-jet ink composition according to this embodiment preferably contains the glycol ether. The glycol ether is not particularly limited. Examples of the glycol ether include glycol diethers and glycol monoethers.

As the glycol diethers, the following ethers can be cited: dialkyl ethers of glycols selected from ethylene glycol, diethylene glycol, triethylene glycol, polyethylene glycol, propylene glycol, dipropylene glycol, tripropylene glycol, polypropylene glycol, polyoxyethylene polyoxypropylene glycol, and the like. In particular, the following ethers are cited: ethylene glycol dimethyl ether, ethylene glycol diethyl ether, ethylene glycol dibutyl ether, diethylene glycol dimethyl ether, diethylene glycol diethyl ether, diethylene glycol ethyl methyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and the like.

As the glycol monoethers, the following ethers can be cited: monoalkyl ethers of glycols selected from ethylene glycol, diethylene glycol, triethylene glycol, polyethylene glycol, propylene glycol, dipropylene glycol, tripropylene glycol, polypropylene glycol, polyoxyethylene polyoxypropylene glycol, and the like. In particular, the following ethers are cited: ethylene glycol monomethyl ether, ethylene glycol monoethyl ether, ethylene glycol mono-n-propyl ether, diethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, dipropylene glycol monoethyl ether, and the like.

Among these glycol ethers, the aqueous ink-jet ink composition preferably contains a compound represented by a formula below as a glycol ether. When the compound is contained, fixability tends to be further enhanced.

R¹O—(R²O)ₙ—H (1)

(R¹ is an alkyl group containing one to eight carbon atoms, R² is an alkylene group containing two to four carbon atoms, and n is an integer of 1 to 10).

The following ethers can be exemplified as a glycol ether represented by Formula (1): for example, ethylene glycol monomethyl ether, diethylene glycol monomethyl ether, triethylene glycol monomethyl ether (TEGmME), triethylene glycol monoethyl ether (TEGmEE), triethylene glycol monobutyl ether (TEGmBE), tetraethylene glycol monomethyl ether, propylene glycol monomethyl ether, and the like. The glycol ether represented by Formula (1) is preferably any one of triethylene glycol monomethyl ether (TEGmME), triethylene glycol monoethyl ether (TEGmEE), and triethylene glycol monobutyl ether (TEGmBE); is more preferably triethylene glycol monomethyl ether (TEGmME) or triethylene glycol monoethyl ether (TEGmEE); and is particularly preferably glycol monomethyl ether (TEGmME). When the about compound is contained as a glycol ether, fixability tends to be more excellent.

The glycol ether may be contained alone or in combination with two or more glycol ethers.

The content of the glycol ether is preferably 0.5% by mass to 5.0% by mass, more preferably 1.0% by mass to 4.0% by mass, further more preferably 1.5% by mass to 3.5% by mass, and particularly preferably 2.0% by mass to 3.0% by mass with respect to the amount (100% by mass) of the ink composition. When the content of the glycol ether is in the above range, fixability tends to be more excellent.

### 1.6.2. Another Solvent

The aqueous ink-jet ink composition according to this embodiment preferably may contain a solvent other than the glycol ether. Examples of the solvent include 1,2-alkanediols, polyhydric alcohols, and cyclic amides. These can be used alone or in combination.

Examples of the 1,2-alkanediols include 1,2-propanediol, 1,2-butanediol, 1,2-pentanediol, 1,2-hexanediol, and 1,2-octanediol. The 1,2-alkanediols have an excellent effect of enhancing the wettability of ink with a recording medium to uniformly wet the recording medium. Therefore, fixability can be further enhanced in some cases. When the 1,2-alkanediols are contained, the content thereof is preferably 1% by mass to 5% by mass with respect to the amount of the ink composition.

Examples of the polyhydric alcohols include ethylene glycol, diethylene glycol, triethylene glycol, propylene glycol, dipropylene glycol, 1,3-propanediol, 1,3-butanediol, 1,3-pentanediol, 1,4-butanediol, 1,5-pentanediol, 1,6-hexanediol, 2,3-butanediol, 3-methyl-1,3-butanediol, 3-methyl-1,5-pentanediol, 2-methyl-1,3-propanediol, 2,2-dimethyl-1,3-propanediol, 2-methyl-2,4-pentanediol, and glycerin. Adding the polyhydric alcohols to ink reduces the drying and solidification of the ink in a discharge nozzle of an ink jet head and tends to enable, for example, the clogging or discharge failure of the discharge nozzle to be reduced. When the polyhydric alcohols are contained, the content thereof is preferably 2% by mass to 20% by mass with respect to the amount of the ink composition. Polyhydric alcohols that are solid at 20° C. have substantially the same action as that of the polyhydric alcohols of solvent and may be similarly used. Examples of the polyhydric alcohols that are solid at 20° C. include trimethylolpropane.

Examples of the cyclic amides include compounds having a ring structure containing an amide group. Examples of the compounds include γ-lactams such as 2-pyrrolidone, 1-methyl-2-pyrrolidone (N-methyl-2-pyrrolidone), 1-ethyl-2-pyrrolidone (N-ethyl-2-pyrrolidone), 1-propyl-2-pyrrolidone, 1-butyl-2-pyrrolidone, and N-vinyl-2-pyrrolidone (NVP); β-lactams; δ-lactams; and ε-lactams such as ε-caprolactam.

### 1.7. pH Adjustor

The aqueous ink-jet ink composition according to this embodiment preferably contains a pH adjustor for the purpose of enhancing the dispersion stability of the ink composition. The pH adjustor is an appropriate combination of an acid, a base, a weak acid, and a weak base. Examples of an acid and base used in such a combination include an inorganic acid, an inorganic base, an organic acid, and an organic base.

Examples of the inorganic acid include sulfuric acid, hydrochloric acid, and nitric acid.

Examples of the inorganic base include lithium hydroxide, sodium hydroxide, potassium hydroxide, dihydrogen potassium phosphate, hydrogen disodium phosphate, potassium carbonate, sodium carbonate, hydrogen sodium carbonate, and ammonia.

The organic acid used may be, for example, adipic acid; citric acid; succinic acid; lactic acid; a Good's buffer such as N,N-bis(2-hydroxyethyl)-2-aminoethanesulfonic acid (BES), 4-(2-hydroxyethyl)-1-piperazineethanesulfonic acid (HEPES), morpholinoethanesulfonic acid (MES), carbamoylmethyl iminobisacetic acid (ADA), piperazine-1,4-bis(2-ethanesulfonic acid) (PIPES), N-(2-acetamide)-2-aminoethanesulfonic acid (ACES), cholamine chloride, N-tris(hydroxymethyl)methyl-2-aminoethanesulfonic acid (TES), acetamide glycine, tricine, glycine amide, or bicine; a phosphate buffer solution; a citrate buffer solution; or a tris buffer solution.

For example, the organic base is an organic amine. Examples of the organic amine include triethanolamine (TEA), diethanolamine, monoethanolamine, tripropanolamine, triisopropanolamine, diisopropanolamine, and tris(hydroxymethyl)aminomethane.

Among these, the organic amine is preferably used. When an inorganic base such as potassium hydroxide is used, the drying of the ink composition proceeds and therefore the ink composition is concentrated, thereby causing the aggregation of pigment, resin, or the like in some cases. In particular, in a micro-space such as a nozzle of an ink jet head, aggregation is likely to occur significantly. However, when the organic amine is used, the aggregation of the ink composition is reduced and unclogging properties tend to be more excellent.

### 1.8. Another Component

The aqueous ink-jet ink composition according to this embodiment may contain a surfactant or the like.

### Surfactant

The aqueous ink-jet ink composition according to this embodiment may contain the surfactant. The surfactant can be used to reduce the surface tension of the aqueous ink-jet ink composition to adjust or enhance the wettability with recording media, for example, the permeability through fabric and the like. The surfactant used may be either of a nonionic surfactant, an anionic surfactant, a cationic surfactant, and an amphoteric surfactant. Furthermore, these may be used in combination. Among surfactants, an acetylene glycol surfactant, a silicone surfactant, and a fluorinated surfactant can be satisfactorily used.

The acetylene glycol surfactant is not particularly limited. Examples of the acetylene glycol surfactant include Surfynols 104, 104E, 104H, 104A, 104BC, 104DPM, 104PA, 104PG-50, 104S, 420, 440, 465, 485, SE, SE-F, 504, 61, DF37, CT111, CT121, CT131, CT136, TG, GA, and DF110D (trade names, produced by Air Products and Chemicals, Inc.); Olfines B, Y, P, A, STG, SPC, E1004, E1010, PD-001, PD-002W, PD-003, PD-004, PD-005, EXP. 4001, EXP. 4036, EXP. 4051, EXP. 4123, EXP. 4300, AF-103, AF-104, AK-02, SK-14, and AE-3 (trade names, produced by Nissin Chemical Industry Co., Ltd.); and Acetylenols E00, E00P, E40, and E100 (trade names, produced by Kawaken Fine Chemicals Co., Ltd.).

The silicone surfactant is not particularly limited and is preferably a polysiloxane compound. The polysiloxane compound is not particularly limited and is, for example, a polyether-modified organosiloxane. Examples of a commercially available product of the polyether-modified organosiloxane include BYK-306, BYK-307, BYK-333, BYK-341, BYK-345, BYK-346, BYK-348 (trade names, produced by BYK Chemie Japan K.K.), KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, produced by Shin-Etsu Chemical Co., Ltd.).

The fluorinated surfactant is preferably a fluorine-modified polymer, of which an example is BYK-340 (trade name, produced by BYK Chemie Japan K.K.).

When surfactants are blended with the aqueous ink-jet ink composition, the sum of the amounts of the surfactants is preferably 0.01% by mass to 3% by mass, more preferably 0.05% by mass to 2% by mass, further more preferably 0.1% by mass to 1.5% by mass, and particularly preferably 0.2% by mass to 1% by mass with respect to the whole of the aqueous ink-jet ink composition. When the content of the surfactants is in the above range, unclogging properties are more excellent in some cases.

### Others

The aqueous ink-jet ink composition according to this embodiment may contain additives, such as a chelating agent, ureas, a preservative/fungicide, a rust preventive, sugar, an oxidation inhibitor, an ultraviolet absorber, and an oxygen absorber, usually usable in aqueous ink-jet ink compositions for ink jet as other components.

### 1.9. Physical Properties and Like

The aqueous ink-jet ink composition according to this embodiment can be obtained in such a manner that the above-mentioned components are mixed together in an arbitrary order and impurities are removed by filtration or the like as required. As a mixing method, a method in which materials are sequentially added to a container equipped with a stirring device such as a mechanical stirrer or a magnetic stirrer and are mixed together by stirring is preferably used. As a filtration method, for example, centrifugal filtration, filter filtration, or the like may be performed as required.

The aqueous ink-jet ink composition preferably has a surface tension of 20 mN/m to 40 mN/m at 20° C. and more preferably 22 mN/m to 35 mN/m from the viewpoint of reliability as an ink-jet ink. The aqueous ink-jet ink composition preferably has a viscosity of 1.5 mPa·s to 10 mPa·s at 20° C. and more preferably 2 mPa·s to 8 mPa·s from a similar viewpoint. A technique for adjusting the surface tension and the viscosity in the above ranges is to adjust the type of the above-mentioned solvent or surfactant and the amount of added water and these, for example.

### 1.10. Applications

The aqueous ink-jet ink composition according to this embodiment can be satisfactorily used in an ink jet recording apparatus equipped with a line head. The line head is likely to be clogged because the number of nozzles is relatively large; hence, higher unclogging properties are required. The aqueous ink-jet ink composition according to this embodiment can ensure good unclogging properties even when the aqueous ink-jet ink composition is used in the ink jet recording apparatus including the line head, thereby enabling both good fixability and unclogging properties to be ensured.

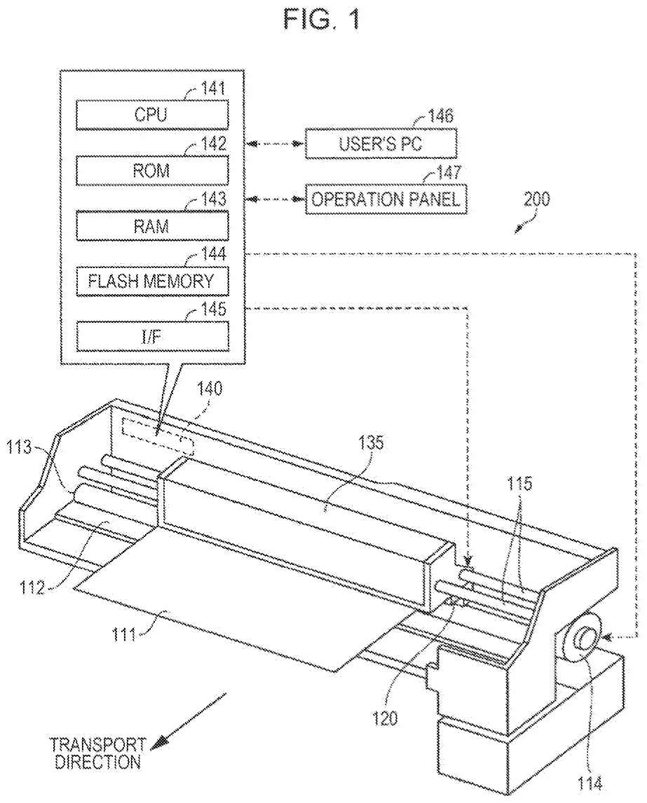

An example of an ink jet recording apparatus equipped with a line head in which the aqueous ink-jet ink composition according to this embodiment can be used is described below with reference to drawings. FIG. 1 is a schematic view showing the configuration of an ink jet recording apparatus equipped with a line head.

As shown in FIG. 1, an ink jet recording apparatus 200 includes a transport roller 113 which transports a recording medium 111 onto a platen 112, a stepping motor 114 which rotationally drives the transport roller 113, a line head 120 which is movably attached with guide rails 115 in a perpendicular direction relative to a transport direction (an arrow direction in FIG. 1) of the recording medium 111 and which discharges ink droplets toward the transported recording medium 111, a vibrating component (not shown) which vibrates the line head 120 in the perpendicular direction relative to the transport direction of the recording medium 111, an ink cartridge 135, and a controller 140 which controls the whole apparatus.

The vibrating component is composed of, for example, a piezoelectric element (electrostrictive vibrator) made of PZT or the like and is attached to the line head 120. Thus, the line head 120 can be vibrated in the perpendicular direction relative to the transport direction of the recording medium 111 along the guide rails 115 by vibrating the vibrating component. Incidentally, vibrating in the perpendicular direction is not essential.

The controller 140 is composed in the form of a microprocessor centered by a CPU 141 and includes a ROM 142 which stores various processing programs, a RAM 143 which temporarily stores data, a flash memory 144 in which data can be written and can be erased, an interface (I/F) 145 which exchanges information with an external device, and an input-output port, which is not shown, in addition to the CPU 141.

The RAM 143 is provided with a print buffer region such that print data received from a user's PC 146 through the interface (I/F) 145 can be stored in the print buffer region. For example, various operation signals are input to the controller 140 from an operation panel 147 through the input-output port. For example, a driving signal, a driving signal, and an output signal are output from the controller 140 to the line head 120, the stepping motor 114, and the operation panel 147, respectively, through the input-output port.

The operation panel 147 is a device for inputting various instructions from a user and for displaying and outputting a status and is provided with a display (not shown) on which characters, figures, or symbols corresponding to various instructions are displayed and buttons (not shown) used by a user to perform various operations.

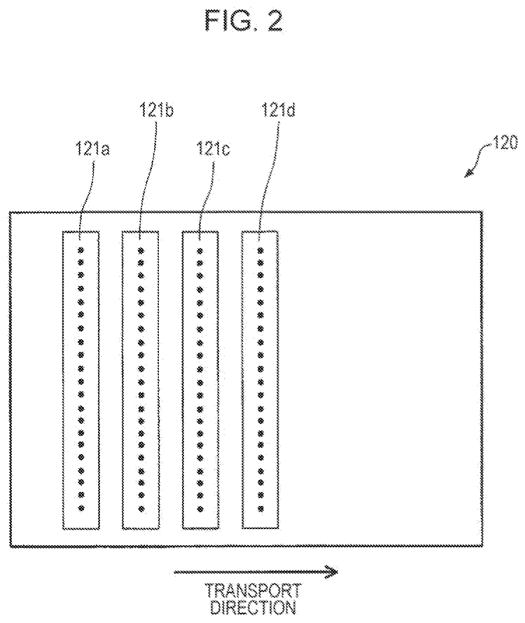

FIG. 2 is a schematic plan view showing the structure of the line head 120. As shown in FIG. 2, the line head 120 includes nozzle arrays 121a, 121b, 121c, and 121d each including a plurality of nozzles arranged in a direction perpendicular to the transport direction, has a recording region larger than or equal to the width of the recording medium 111 that is transported, and can record a one-line image by one operation on the recording medium 111 that is transported. Recording in which two or more scans are performed can be performed in such a manner that after a scan in which the recording medium 111 is transported is performed once, a scan in which the recording medium 111 is returned in a direction opposite to the transport direction and is transported again is performed again. In this case, the position of the line head 120 in a perpendicular direction relative to the transport direction is changed between scans and a second or subsequent scan is performed at different positions, thereby enabling the recording resolution in the perpendicular direction to be increased. In this case, the above-mentioned vibration of the line head 120 need not be particularly performed. When none of the above-mentioned vibration of the line head 120 and the change in position of the line head 120 in the perpendicular direction is performed, the amount of the ink composition applied to the recording medium 111 can be increased by performing two or more scans. Furthermore, a scan may be performed in such a manner that the relative position of the recording medium 111 to the line head 120 is varied or in such a manner that the line head 120 is moved to the recording medium 111 fixed to a platen region. Such a recording method is, for example, one described in JP-A-2009-90635 or the like. Incidentally, the transport of the recording medium 111, the movement of a carriage equipped with a head, or the like is the change of the relative position of the recording medium 111 to the line head 120.

In an example in FIG. 1, as a method for discharging ink from the line head 120, a method in which droplets of the ink composition are discharged by the pressure generated in an ink pressure chamber of the line head 120 using a vibrating component, which is not shown, is used. The method for discharging ink is not limited to this method. Various processes such as a thermal ink jet process in which a pressure is applied to the ink composition by generating bubbles with a heating element can be used.

In the ink jet recording apparatus 200, each ink composition is discharged and is applied to the recording medium 111 sequentially using, for example, the nozzle arrays 121a, 121b, 121c, and 121d. The line head 120 is not limited to this configuration and may be composed of a plurality of arrayed line-type heads each including a single nozzle array. In this case, a configuration in which the line-type heads are spaced may be used. The nozzle arrays 121a, 121b, 121c, and 121d of the line head 120 are arranged in a direction perpendicular to the transport direction in FIG. 2 and may be arranged in a direction crossing the transport direction.

### 2. Examples

The present disclosure is further described below in detail with reference to examples. The present disclosure is not limited to the examples. Hereinafter, “%” is on a mass basis unless otherwise specified.

### 2.1. Preparation of Aqueous Ink-Jet Ink Compositions

Components were put in a container so as to give compositions shown in Table 1 below and were mixed and stirred for two hours using a magnetic stirrer, followed by filtration using a membrane filter with a pore size of 5 μm, whereby aqueous ink-jet ink compositions according to the examples and comparative examples were obtained. Incidentally, the values of pigments, resin particles, and a surfactant in the table represent the solid equivalents thereof.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Pigment | Black pigment | 6 | 6 | 6 | 6 | 6 | 6 | 6 | 6 | 6 | 6 | 6 |
| | Cyan pigment | — | — | — | — | — | — | — | — | — | — | — |
| | Magenta pigment | — | — | — | — | — | — | — | — | — | — | — |
| | Yellow pigment | — | — | — | — | — | — | — | — | — | — | — |
| Resin | Superflex 420 | 5 | — | — | — | — | — | — | — | — | — | — |
| particles | X-436 | — | 5 | 4 | 2 | 0.5 | 2 | 2 | 2 | 2 | 2 | 2 |
| Amino acid | Trimethylglycine | 2 | 2 | 2 | 2 | 2 | 2 | 2 | 2 | 2 | 2 | 2 |
| Solvent | HEP | 2 | 2 | 2 | 2 | 2 | 2 | 2 | 2 | 2 | 2 | 2 |
| | Glycerin | 8 | 8 | 8 | 10 | 10 | 10 | 10 | 10 | 10 | 10 | 10 |
| Solvent | TEGmBE | — | — | — | — | — | 6 | 4 | 2 | 0.5 | 2 | 2 |
| (penetrant) | TEGmME | — | — | — | — | — | — | — | — | — | 2 | — |
| | TEGmEE | — | — | — | — | — | — | — | — | — | — | 2 |
| | 1,2-Hexanediol | 5 | 5 | 5 | 5 | 5 | 1 | 1 | 1 | 1 | 1 | 1 |
| Surfactant | Olfine E1010 | 1 | 1 | 1 | 1 | 1 | 1 | 1 | 1 | 1 | 1 | 1 |
| pH Adjustor | Potassium hydroxide | 0.5 | 0.5 | 0.5 | 0.5 | 0.5 | 0.5 | 0.5 | 0.5 | 0.5 | 0.5 | 0.5 |
| | TEA | — | — | — | — | — | — | — | — | — | — | — |
| Water | Pure water | 70.5 | 71 | 72 | 72 | 73 | 70 | 72 | 74 | 76 | 72 | 72 |
| Fixability | Line marker resistance | B | B | B | B | B | A | A | A | A | A | A |
| Unclogging | 40° C.*3 d | B | B | A | A | A | B | A | A | A | A | A |
| properties | 40° C.*7 d | B | B | B | B | B | B | B | B | B | A | A |
| | 40° C.*14 d | B | B | B | B | B | B | B | B | B | B | B |
| | | Example | | | | | | Comparative Example | | | | |
| | | 12 | 13 | 14 | 15 | 16 | 17 | 1 | 2 | 3 | 4 | 5 |
| Pigment | Black pigment | 6 | 6 | 6 | — | — | — | 6 | 6 | 6 | 6 | 6 |
| | Cyan pigment | — | — | — | 4 | — | — | — | — | — | — | — |
| | Magenta pigment | — | — | — | — | 5 | — | — | — | — | — | — |
| | Yellow pigment | — | — | — | — | — | 4 | — | — | — | — | — |
| Resin | Superflex 420 | — | — | — | — | — | — | — | — | — | — | — |
| particles | X-436 | 2 | 2 | 2 | 1 | 1 | 1 | 7 | 0.5 | 5 | 7 | 5 |
| Amino acid | Trimethylglycine | 2 | 2 | 2 | 2 | 2 | 2 | — | — | — | 2 | 2 |
| Solvent | HEP | 2 | 2 | 2 | 1 | 1 | 1 | — | — | 2 | 2 | — |
| | Glycerin | 10 | 10 | 10 | 10 | 10 | 10 | 8 | 10 | 8 | 8 | 8 |
| Solvent | TEGmBE | — | 2 | 2 | 2 | 2 | 2 | — | — | — | — | — |
| (penetrant) | TEGmME | 4 | 2 | 2 | 2 | 2 | 2 | — | — | — | — | — |
| | TEGmEE | — | — | — | — | — | — | — | — | — | — | — |
| | 1,2-Hexanediol | — | — | 1 | 1 | 1 | 1 | 5 | 5 | 5 | 5 | 5 |
| Surfactant | Olfine E1010 | 1 | 1 | 1 | 1 | 1 | 1 | 1 | 1 | 1 | 1 | 1 |
| pH Adjustor | Potassium hydroxide | 0.5 | 0.5 | — | — | — | — | 0.5 | 0.5 | 0.5 | 0.5 | 0.5 |
| | TEA | — | — | 1.0 | 1.0 | 1.0 | 1.0 | — | — | — | — | — |
| Water | Pure water | 73 | 73 | 72 | 76 | 75 | 76 | 72.5 | 77.0 | 72.5 | 68.5 | 72.5 |
| Fixability | Line marker resistance | A | A | A | A | A | A | B | D | B | A | C |
| Unclogging | 40° C.*3 d | A | A | A | A | A | A | D | B | C | C | C |
| properties | 40° C.*7 d | A | A | A | A | A | A | D | C | C | C | C |
| | 40° C.*14 d | B | B | A | A | A | A | D | D | C | C | C |

For the components shown in Table 1, descriptions are supplemented.

Pigments

Black pigment: (trade name “CAB-O-JET® 300”, produced by Cabot Specialty Chemicals Inc., self-dispersing carbon black dispersion)

Cyan pigment: (trade name “CAB-O-JET® 250C”, produced by Cabot Specialty Chemicals Inc., self-dispersing cyan pigment dispersion)

Magenta pigment: (trade name “CAB-O-JET® 260M”, produced by Cabot Specialty Chemicals Inc., self-dispersing magenta pigment dispersion)

Yellow pigment: (trade name “CAB-O-JET® 470Y”, produced by Cabot Specialty Chemicals Inc., self-dispersing yellow pigment dispersion)

Resin Particles

Superflex 420: (trade name, produced by Dai-ichi Kogyo Seiyaku Co., Ltd., urethanic resin emulsion)

X-436 (trade name, produced by Seiko Polymer Corporation, styrene-acrylic emulsion)

Solvent

HEP: 1-(2-hydroxyethyl)-2-pyrrolidone

Solvent (penetrant)

TEGmBE: triethylene glycol monobutyl ether

TEGmME: triethylene glycol monomethyl ether

TEGmEE: triethylene glycol monoethyl ether

Surfactant

Olfine E1010: (trade name, produced by Nissin Chemical Industry Co., Ltd., acetylene glycol surfactant)

pH Adjustor

TEA: triethanolamine

### 2.2. Evaluation Methods

### 2.2.1. Evaluation of Fixability (Line Marker Resistance)

An ink cartridge of a printer, “PX-M860F”, manufactured by Seiko Epson Corporation was filled with each aqueous ink-jet ink composition obtained as described above and followed by printing a character pattern on a recording medium in an environment with a temperature of 25° C. and a relative humidity of 50%. Incidentally, the recording medium used was A4-size (210 mm×297 mm) copy paper, “Xerox P Paper” (manufactured by Fuji Xerox Co., Ltd., a basis weight of 64 g/m², a thickness of 88 μm). A character portion was rubbed with a line marker, “OPTEX CARE” (Zebra Co., Ltd.), immediately after printing and the bleeding of ink was determined in accordance with criteria below. Level B or higher was regarded as good.

Evaluation Criteria

A: No bleeding is found in a rubbed portion.

B: Bleeding is found in a rubbed portion and is inconspicuous.

C: Bleeding is found in a rubbed portion and is slightly conspicuous.

D: Bleeding is found in a rubbed portion and is fairly conspicuous.

### 2.2.2. Evaluation of Unclogging Properties

An ink cartridge of a printer, “PX-M860F”, manufactured by Seiko Epson Corporation was filled with each aqueous ink-jet ink composition obtained as described above, followed by printing. The printer was turned off in the middle of printing and was put into such a state that a recording head was detached from a cap. Thereafter, the printer was left for arbitrary days in a 40° C. environment. In particular, the printer was left for three days in a 40° C. environment (40° C.*3 d), seven days in a 40° C. environment (40° C.*7 d), or 14 days in a 40° C. environment (40° C.*14 d). After leaving, in the printer left for arbitrary days, nozzles were repeatedly cleaned until all the nozzles were unclogged and were determined in accordance with criteria below. Level B or higher was regarded as good. When substantially the same evaluation was performed using a printer, “LX-10050MF”, manufactured by Seiko Epson Corporation, the printer being equipped with a line head, a rating of B or higher was obtained in a case where each of aqueous ink-jet ink compositions of Examples 1 to 17 was used.

Evaluation Criteria

A: Unclogged by performing cleaning less than three times.

B: Unclogged by performing cleaning three to less than six times.

C: Unclogged by performing cleaning six to less than nine times.

D: Not unclogged by performing cleaning nine or more times.

### 2.3. Evaluation Results

Evaluation results are shown in Table 1.

The aqueous ink-jet ink composition of each example that contained pigment, water, resin particles, 1-(2-hydroxyethyl)-2-pyrrolidone (HEP), and trimethylglycine and that was such that the mass-based content of the resin particles was lower than the mass-based content of the pigment could ensure both good fixability and unclogging properties.

However, in each comparative example, none of specific components was contained, the quantitative ratio relationship between the specific components was satisfied, or both held and therefore both good fixability and unclogging properties could not be ensured.

Contents below are derived from the above-mentioned embodiments.

An aspect of an aqueous ink-jet ink composition contains pigment, water, resin particles, 1-(2-hydroxyethyl)-2-pyrrolidone, and trimethylglycine. The mass-based content of the resin particles is lower than the mass-based content of the pigment.

In an aspect of the aqueous ink-jet ink composition, the content of the resin particles may be 0.5% by mass to 5.0% by mass with respect to the amount of the ink composition.

An aspect of the aqueous ink-jet ink composition may contain a glycol ether as a solvent.

In an aspect of the aqueous ink-jet ink composition, the content of the glycol ether may be 0.5% by mass to 5.0% by mass with respect to the amount of the ink composition.

In an aspect of the aqueous ink-jet ink composition, the glycol ether may be a compound represented by the following formula (1):

R¹O—(R²O)ₙ—H (1)

(R¹ is an alkyl group containing one to eight carbon atoms, R² is an alkylene group containing two to four carbon atoms, and n is an integer of 1 to 10).

An aspect of the aqueous ink-jet ink composition may further contain an organic amine.

An aspect of the aqueous ink-jet ink composition may be one for use in an ink jet recording apparatus equipped with a line head.

The present disclosure is not limited to the above-mentioned embodiments and various modifications can be made. The present disclosure includes, for example, substantially the same configurations as configurations described in the embodiments, that is, configurations identical in function, method, and result or configurations identical in object and effect. The present disclosure includes configurations obtained by replacing nonessential portions of configurations described in the embodiments. The present disclosure includes configurations capable of providing the same advantageous effects as those of configurations described in the embodiments or capable of achieving the same object. Furthermore, the present disclosure includes configurations obtained by adding a known technique to configurations described in the embodiments.

What is claimed is:

1. An aqueous ink-jet ink composition comprising:
pigment;
water;
resin particles;
1-(2-hydroxyethyl)-2-pyrrolidone; and
trimethylglycine, wherein
a mass-based content of the resin particles is lower than a mass-based content of the pigment.

2. The aqueous ink-jet ink composition according to claim 1, wherein
the content of the resin particles is 0.5% by mass to 5.0% by mass with respect to an amount of the ink composition.

3. The aqueous ink-jet ink composition according to claim 1, further comprising a glycol ether as a solvent.

4. The aqueous ink-jet ink composition according to claim 3, wherein
a content of the glycol ether is 0.5% by mass to 5.0% by mass with respect to an amount of the ink composition.

5. The aqueous ink-jet ink composition according to claim 3, wherein
the glycol ether is a compound represented by a following formula (1):
R¹O—(R²O)ₙ—H (1)
where R¹ is an alkyl group containing one to eight carbon atoms, R² is an alkylene group containing two to four carbon atoms, and n is an integer of 1 to 10.

6. The aqueous ink-jet ink composition according to claim 1, further comprising an organic amine.

7. The aqueous ink-jet ink composition according to claim 1, being used in an ink jet recording apparatus equipped with a line head.
